(19) United States
(12) Patent Application Publication
(10) Pub. No.: US 2026/0357969 A1
(43) Pub. Date: Nov. 12, 2026

(54) Arrangement comprising a spring element

(71) Applicant: SIGNIFY HOLDING B.V., EINDHOVEN (NL)

(72) Inventors: DANIEL KUNIKOWSKI, KETRZYN (PL); GRZEGORZ SULEJ, KETRZYN (PL)

(21) Appl. No.: 19/153,510

(22) PCT Filed: Jan. 30, 2024
(86) PCT No.: PCT/EP2024/052218

§ 371 Date: Aug. 4, 2025

(30) Foreign Application Priority Data
Feb. 3, 2023 (EP) 23154823.1

(51) Int. Cl. F21V 15/01; F21S 8/08; F21V 23/06; F21W 131/103

(52) U.S. Cl. CPC F21V 15/01; F21S 8/086; F21V 23/06; F21W 2131/103

(57) ABSTRACT

There is provided an arrangement (100), comprising a housing (200) with a first housing portion (210) and a second housing portion (220) releaseably attachable to each other, an electrical connector (300) comprising a male connector element (310 ) attached to the first housing portion, and a female connector element (320) attached to the second housing portion, wherein the male and female connector elements are configured for mating engagement along a first axis, A, upon attachment. The arrangement further comprises a spring element (400) arranged between one of the first and second housing portion and the associated connector element and comprising a ridge (410). In a non-biased state (420) of the spring element, the ridge defines a clearance, C, between the housing portion and the associated connector element. In a biased state (430) of the spring element, the ridge is at least partially flattened between the housing portion and the associated connector element.

### FIELD OF THE INVENTION

The present invention generally relates to structures, arrangements or devices comprising electronics. More specifically, the present invention is related to an arrangement which provides and/or assures electrical contact of electrical components.

### BACKGROUND OF THE INVENTION

For any kind of electrical contact such as a plug and socket, male and female contact elements, etc., it is desirable to achieve and assure a satisfactory contact between the electrical contact components. It is furthermore desirable to overcome, or at least minimize, backlash, which is a clearance or lost motion in a mechanism caused by gap(s) between parts of the mechanism. It will be appreciated that backlash is an effect commonly associated with (electric) couplings.

A knife switch connector is an example of an electrical contact comprising two parts arranged for mating contact. More specifically, the knife switch connector may comprise a male part with a plurality of projecting electrical pins, and a female part comprising a plurality of (electrical) openings arranged to matingly receive the plurality of projecting electrical pins of the male contact upon connection of the knife switch connector.

As backlash may occur for electrical contacts such as knife switch connectors in the prior art, it is desirable to try to overcome, or at least mitigate and/or minimize, this effect, for an improved electrical contact.

Hence, it is an object of the present invention to provide improved arrangements comprising electrical contacts which counteract backlash and which are able to achieve and assure a satisfactory contact between the electrical contact components.

### SUMMARY OF THE INVENTION

It is of interest to provide alternatives to arrangements of the prior art in order to counteract backlash and to achieve and assure a satisfactory contact between the electrical contact components.

This and other objects are achieved by providing an arrangement having the features in the independent claims. Preferred embodiments are defined in the dependent claims.

According to the present invention, there is provided an arrangement. The arrangement comprises a housing, comprising a first housing portion, and a second housing portion, wherein the first housing portion and the second housing portion are releaseably attachable to each other. The arrangement further comprises an electrical connector, at least partially enclosed by the housing, wherein the electrical connector comprises a male connector element attached to the first housing portion, and a female connector element attached to the second housing portion, wherein the male connector element and the female connector element are configured for mating engagement along a first axis, A, upon attachment of the first housing portion and the second housing portion. The arrangement further comprises a spring element arranged between the second housing portion and the female connector element or between the first housing portion and the male connector element. The spring element comprises a ridge extending parallel to the first axis, A, wherein the ridge, in a non-biased state of the spring element, defines a clearance, C, between the second housing portion and the female connector element or between the first housing portion and the male connector element, and wherein the ridge, in a biased state of the spring element, is at least partially flattened between the second housing portion and the female connector element or between the first housing portion and the male connector element.

Thus, the present invention is based on the concept or idea of providing an arrangement for an improved electrical connection, via the male and female connector elements, upon mechanical closure of the housing, via the first and second housing portions thereof. The spring element, arranged between the second housing portion and the female connector element or between the first housing portion and the male connector element, efficiently counteracts and/or compensates backlash between the male and female connector elements upon mating engagement of the connector elements and the associated closure of the housing.

The present invention is advantageous in that the spring element conveniently and efficiently counteracts, mitigates and/or avoids backlash between the male and female connector elements upon mating engagement of the connector elements and the associated closure of the housing of the arrangement. Before attachment or engagement between the male and female connector elements of the arrangement, the spring element conveniently defines the clearance, C, between the second housing portion and the female connector element or between the first housing portion and the male connector element via its ridge. Upon closure of the housing and the attachment or engagement between the male and female connector elements of the arrangement, the ridge of the spring element conveniently bends, leading to an improved connection operation of the arrangement.

The present invention is further advantageous in that an improved electrical connection is provided between the male and female connector elements. It is required and/or needed that the male and female connector elements of an electrical connector make sufficient electrical contact upon connection, without hampering the closure of the housing portions to which the connector elements are attached, and the arrangement of the present invention meet these requirements in an efficient and convenient way via the features of the spring element. Furthermore, it should be noted that in case the male and female connector elements are mutually to remote from each other, in order to try to enable a good closure of the housing, sparking may occur. The present invention overcomes, or at least mitigates the risk of such sparking, by the spring plate of the arrangement as provided between the second housing portion and the female connector element or between the first housing portion and the male connector element.

The present embodiment is further advantageous in its cost-efficiency, as the arrangement, by its non-complex structure whilst still achieving the desired connection properties, implies an easy and (cost) efficient manufacture and assembly of its components.

The arrangement comprises a housing, comprising a first housing portion, and a second housing portion. By the term “housing”, it is here meant substantially any housing, cover or enclosure, arranged to accommodate and/or enclose one or more components. The first housing portion and the second housing portion are releaseably attachable to each other, meaning that the first and second housing portions are (mechanically) attachable and separable, via any mechanical attachment means. Releasably attachable portions also comprises hingedly connected first and second housing portions, which upon pivoting over the hinge can be mutually (dis)engaged. The arrangement further comprises an electrical connector, at least partially enclosed by the housing, wherein the electrical connector comprises a male connector element attached to the first housing portion, and a female connector element attached to the second housing portion. Hence, the electrical connector achieves an electric contact upon connection of the male and female connector elements. The male connector element and the female connector element are configured for mating engagement along a first axis, A, upon attachment of the first housing portion and the second housing portion. Hence, the first and second housing are configured for connection along the first axis, A, and upon this connection, the male and female connector element are arranged to matingly engage along the same first axis, A. The arrangement further comprises a spring element arranged between the second housing portion and the female connector element or between the first housing portion and the male connector element. By “spring element”, it is here meant an element which is configured or arranged to deform if subjected to a biasing force and return to its initial shape or form upon release of the biasing force. The spring element comprises a ridge extending parallel to the first axis, A. By “ridge”, it is here meant that at least a part or portion of the spring element has an (inverted) “V”-shape, a shape of a Greek (capital) Lambda “Λ”, or the like, seen in profile of the spring element. In a non-biased state of the spring element, the ridge defines a clearance, C, between the second housing portion and the female connector element or between the first housing portion and the male connector element. Hence, in case of no biasing force applied to the spring element, the (inverted) “V” (or “Λ” shape) defines a clearance, C, or (separating) distance, between the second housing portion and the female connector element or between the first housing portion and the male connector element. In a biased state of the spring element, the ridge is at least partially flattened between the second housing portion and the female connector element or between the first housing portion and the male connector element. Hence, in case of a biasing force applied to the spring element, the (inverted) “V” (or “Λ” shape) is (becomes) at least partially flattened between the second housing portion and the female connector element or between the first housing portion and the male connector element.

According to an embodiment of the present invention, the spring element may comprise a plate-shaped material. By “plate-shaped material” it is here meant substantially any (piece of) material of relatively thin shape in the form of a plate, a sheet, or the like. The plate-shaped material may, for example, be a metal plate. The present embodiment is advantageous in that the ridge of the spring element in the form of a plate-shaped material may be conveniently flattened between the second housing portion and the female connector element or between the first housing portion and the male connector element in a biased state of the spring element upon mating engagement of the connector elements and the associated closure of the housing, leading to an even further ameliorated connection. The present embodiment is further advantageous in that the arrangement is cost-efficient due to the relatively low cost associated with the material and/or non-complex form of the spring element.

According to an embodiment of the present invention, the spring element may extend along a second axis, B, perpendicular to the first axis, A, and has an oblong shape, whereby the ridge extends from peripheral and oppositely arranged first and second base portions of the spring element, to a peak of the ridge, arranged at a central portion of the spring element. Hence, the spring element may have an oblong shape, and the first and second base portions are arranged on either (distal) sides of the spring element. The ridge defines an inverted “V”-shape (in other words, that the ridge defines a Greek (capital) Lambda “Λ”) seen in profile of the spring element, whereby the peak (apex) is at the top of the spring element's inverted “V”-shape (or “Λ” shape). The present embodiment is advantageous in that the spring element is easily manufactured and/or easily inserted into the arrangement.

According to an embodiment of the present invention, the spring element may comprise first and second end portions, arranged peripherally of the first and second base portions, respectively, along the second axis, B, wherein the first and second end portions are inclined with respect to the second axis, B. Hence, and according to the previous embodiment, the spring element may have an oblong shape, whereby the ridge defines an inverted “V”-shape (or “Λ” shape) seen in profile of the spring element, wherein the end portions of the “Λ” shape are inclined.

According to an embodiment of the present invention, the first and second base portions are arranged tangentially with the second axis, B, and wherein the first and second end portions respectively comprises a tip portion, wherein, in a direction parallel to the first axis, A, in the non-biased state of the spring element, a first distance, di, defined between the peak of the ridge and the second axis, B, and a second distance, d₂, defined between the respective tip portion and the second axis, B, fulfil |d₁|>|d₂|. Hence, the second axis, B, extends tangentially with respect to the first and second base portions. Furthermore, the first end portion comprises a (first) tip portion, and the second end portion comprises a (second) tip portion. In a direction parallel to the first axis, A, in the non-biased state of the spring element, the first distance, d₁, is defined between the peak of the ridge and the second axis, B. Furthermore, in a direction parallel to the first axis, A, in the non-biased state of the spring element, the second distance, d₂, defined between the respective tip portion and the second axis, B. The relation between the first distance, d₁, and the second distance, d₂, is |d₁|>|d₂|.

According to an embodiment of the present invention, the respective tip portion is rounded.

According to an embodiment of the present invention, the spring element may comprise first and second notches extending from the first and second end portions, respectively, at least partially into the ridge, along the second axis, B, wherein the first and second notches are arranged to receive a respective fastening element for attachment of the female connector element to the second housing portion or for attachment of the male connector element to the first housing portion. By “notches”, it is here meant cuts, or the like, into the material of the spring element at the first and second end portions. The present embodiment is advantageous in that the first and second notches conveniently allows the receiving of fastening elements, such as bolts, screws, or the like, of the arrangement for attachment of the female connector element to the second housing portion or for attachment of the male connector element to the first housing portion. Hence, the present embodiment is advantageous in that the arrangement, mounting and/or insertion of the spring element in the arrangement is even further facilitated. The present embodiment is further advantageous in that the spring element, via the first and second notches, may be even more firmly positioned in its placement between the second housing portion and the female connector element or between the first housing portion and the male connector element.

According to an embodiment of the present invention, the electrical connector may be a knife switch connector. The present embodiment is advantageous in that a knife switch connector is particularly suitable in the arrangement, whereby the features of the spring element between the second housing portion and the female (knife switch) connector element or between the first housing portion and the male (knife switch) connector element lead to an even further ameliorated connection upon mating engagement of the knife switch connector elements and the associated closure of the housing.

According to an embodiment of the present invention, there is provided a lighting device. By the term “lighting device”, it is here meant substantially any lighting device, lighting arrangement, luminaire, or the like. The lighting device comprises an arrangement according to any of the preceding embodiments, and at least one light source at least partially enclosed by the housing. The present embodiment is advantageous in that the arrangement, via its advantageous mechanical and electrical connection, consequently provides an improved operation of the lighting device.

According to an embodiment of the present invention, there is provided a light pole for street light illumination, wherein the light pole comprises a lighting device according to the previous embodiment. As light poles may be subjected to (extreme) weather conditions and/or that it may be desirable to minimize any service, repair, component replacements, or the like, due to the height of the light poles, the present embodiment is particularly advantageous in that the mechanical and electrical connection of the arrangement provides a stable, convenient and reliable connection.

Further objectives of, features of, and advantages with, the present invention will become apparent when studying the following detailed disclosure, the drawings and the appended claims. Those skilled in the art will realize that different features of the present invention can be combined to create embodiments other than those described in the following.

### BRIEF DESCRIPTION OF THE DRAWINGS

This and other aspects of the present invention will now be described in more detail, with reference to the appended drawings showing embodiment(s) of the invention.

FIG. 1 schematically shows an arrangement according to an exemplifying embodiment of the present invention.

FIG. 2a schematically shows a portion of an arrangement according to an exemplifying embodiment of the present invention.

FIG. 2b schematically shows a spring element of an arrangement according to an exemplifying embodiment of the present invention.

FIG. 2c schematically shows a portion of an arrangement according to an exemplifying embodiment of the present invention.

FIGS. 3a and 3b schematically show a spring element of an arrangement according to exemplifying embodiments of the present invention.

FIG. 4 schematically shows a lighting device comprising an arrangement according to an exemplifying embodiment of the present invention.

FIG. 5 schematically shows a light pole comprising an arrangement according to an exemplifying embodiment of the present invention.

### DETAILED DESCRIPTION

In the drawings, the invention is illustrated at the hand of the spring element being arranged between the female connector element and the second housing portion, but the invention equally applies for the spring element being arranged between the male connector element and the first housing portion.

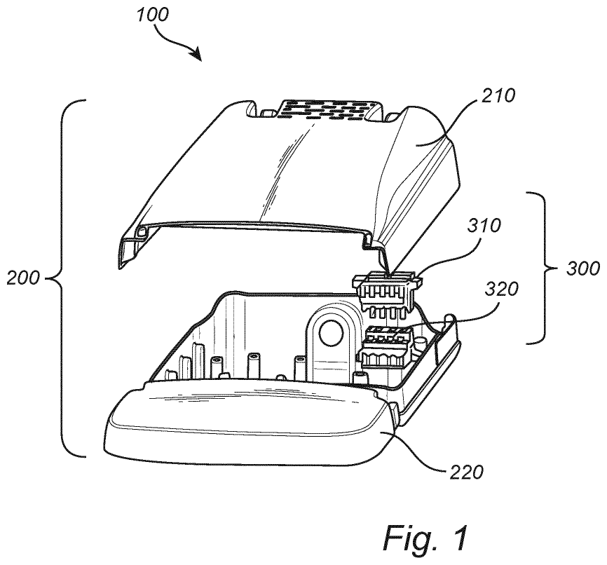

FIG. 1 schematically shows an arrangement 100 according to an exemplifying embodiment of the present invention. It will be appreciated that the arrangement 100 may have substantially any shape, size, etc., and is shown in FIG. 1 as an example. The arrangement comprises a housing 200, which in FIG. 1 is exemplified as a housing for a lighting device, luminaire, light pole, or the like. Hence, the housing 200 may comprise or constitute a cover or enclosure arranged to accommodate and/or enclose one or more components. The housing 200 comprises a (top) first housing portion 210, in the exemplified form of a cover. The housing 200 further comprises a (bottom) second housing portion 220. The first housing portion 210 and the second housing portion 220 of the housing 200 are releaseably attachable to each other, meaning that the first and second housing portions 210, 220 are (mechanically) attachable and separable, via any mechanical attachment means. The arrangement 100 further comprises an electrical connector 300, at least partially enclosed by the housing 200. Here, the electrical connector 300 is exemplified as a knife switch connector. The electrical connector 300 comprises a male connector element 310 which is attached or fastened to the first housing portion 210. The electrical connector 300 further comprises a female connector element 320 attached to the second housing portion 220. The male and female connector elements 310, 320 are arranged to matingly engage upon attachment of the first and second housing portions 210, 220.

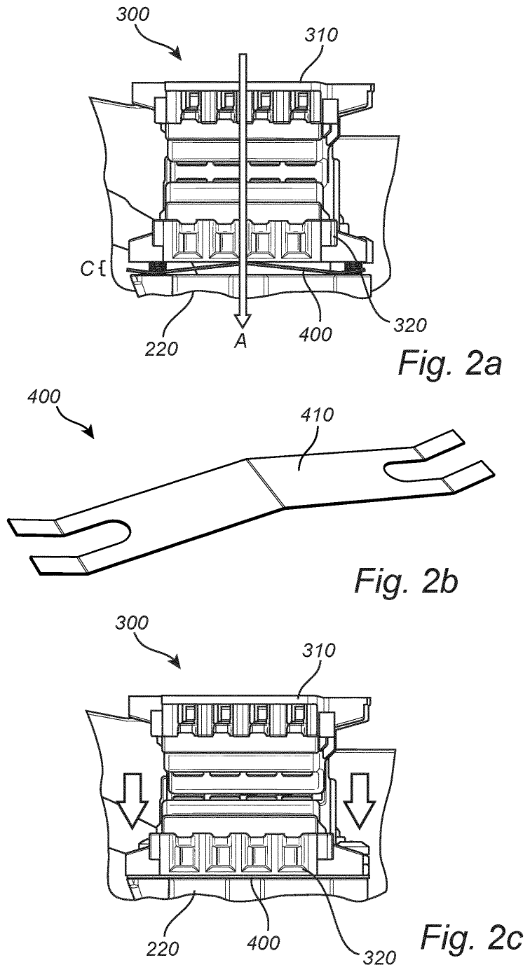

FIG. 2a schematically shows a portion of an arrangement according to an exemplifying embodiment of the present invention, e.g. as presented in FIG. 1, wherein FIG. 2a focuses on the electrical connector 300 of the arrangement. The (top) male connector element 310 and the (bottom) female connector element 320 of the electrical connector 300 of the arrangement 100 are configured for mating engagement along a first axis, A, upon attachment of the first housing portion (not shown in FIG. 2a) and the second housing portion 220. Here, the first axis, A, is disclosed in a downward direction, but may alternatively be disclosed in an upward direction, due to the (reciprocal) connection symmetry of the connection of the male and female connector elements 310, 320. Hence, the male and female connector elements 310, 320 are arranged to matingly engage along, or parallel to, the (vertically indicated) first axis, A. The arrangement 100 further comprises a spring element 400 arranged between the second housing portion 220 and the female connector element 320.

FIG. 2b schematically shows a spring element 400 of an arrangement 100 according to an exemplifying embodiment of the present invention. The spring element 400 comprises a plate-shaped material. For example, the spring element 400 may comprise a metal plate. The spring element 400, which is exemplified as having a gull wing shape, is configured or arranged to deform if subjected to a biasing force and return to its initial shape or form upon release of the biasing force. The spring element 400 comprises a ridge 410, such that at least a part or portion of the spring element 400 has an (inverted) “V”-shape, an “Λ”-shape, or the like, seen in profile of the spring element 400. In a non-biased state of the spring element 400, as indicated in FIG. 2a (and FIG. 2b), the ridge 410 of the spring element 400 defines a clearance, C, between the second housing portion and the female connector element 320. Hence, before connection of the male and female connector elements 310, 320, i.e. in case of no biasing force applied to the spring element 400, the (inverted) “V” (or “Λ” shape) of the spring element 400 defines a clearance, C, or (separating) distance, between the second housing portion and the female connector element 320.

FIG. 2c schematically shows a portion of an arrangement according to an exemplifying embodiment of the present invention, e.g. as presented in FIG. 1, wherein FIG. 2c focuses on the electrical connector 300 of the arrangement. Compared to the non-biased state of the spring element 400 as shown in FIG. 2a, FIG. 2c discloses the biased state of the spring element 400 at connection of the male and female connector elements 310, 320, as indicated by the inserted, vertical arrows. Here, the ridge of the spring element 400 is at least partially flattened between the second housing portion 220 and the female connector element 320. Hence, in case of a biasing force applied to the spring element 400 upon connection of the male and female connector elements 310, 320, the (inverted) “V” (or “Λ” shape) is (becomes) at least partially flattened between the second housing portion 220 and the female connector element 320.

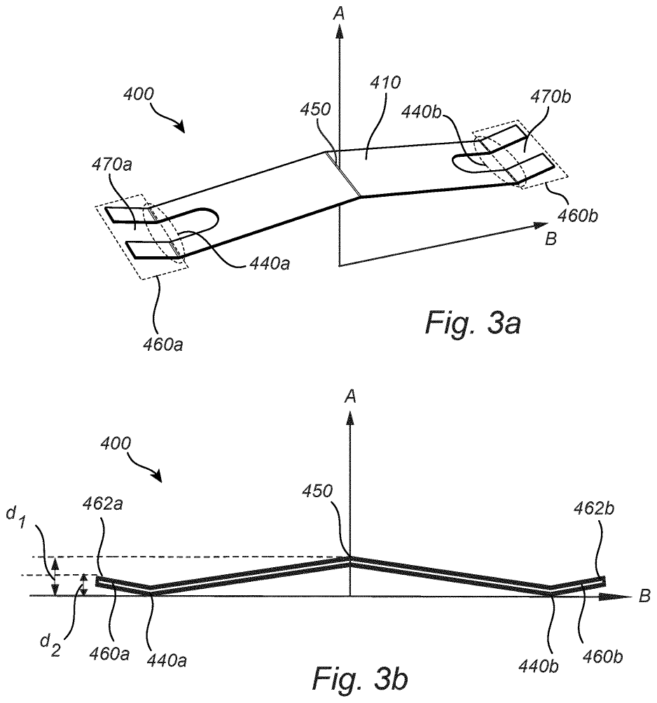

FIG. 3a schematically shows a spring element 400 of an arrangement according to an exemplifying embodiment of the present invention. Analogously to the representation of the spring element 400 according to FIG. 2b, the spring element 400 in FIG. 3a comprises a plate-shaped material, such as a metal plate. The spring element 400, which is exemplified as having a gull wing shape, comprises a ridge 410. The ridge 410 defines an (inverted) “V”-shape, an “Λ”-shape, or the like, of a portion of the spring element 400 seen in profile thereof. The spring element 400 extends along a second axis, B, perpendicular to the first axis, A. The spring element 400 has an oblong shape. The ridge 410 extends from peripheral and oppositely arranged first and second base portions 440a, 440b of the spring element 400 of oblong shape to a peak 450 of the ridge 410, wherein the peak 450 is arranged at a central portion of the spring element 400. According to the example of the spring element 400 of FIG. 3a, the spring element 400 further comprises first and second end portions 460a, 460b which are arranged peripherally of the first and second base portions 440a, 440b, respectively, along the second axis, B. The first and second end portions 460a, 460b are inclined (upwards) with respect to the second axis, B. The spring element 400 as exemplified in FIG. 3a further comprises first and second notches 470a, 470b. The first and second notches 470a, 470b extend from the first and second end portions 460a, 460b, respectively, and at least partially into the ridge 410, along the second axis, B. The first and second notches 470a, 470b are arranged to receive a respective fastening element for attachment of the female connector element to the second housing portion of the arrangement according to the present invention.

FIG. 3b schematically shows a spring element 400 of an arrangement according to an exemplifying embodiment of the present invention. The spring element 400 according to FIG. 3b corresponds to the spring element 400 according to FIG. 3a, and it is also referred to FIG. 3a and the associated text for a description of the spring element 400. In FIG. 3b, it is shown that the first and second base portions 440a, 440b are arranged tangentially with the second axis, B. The first and second end portions 460a, 460b respectively comprises a tip portion 462a, 462b. In a direction parallel to the first axis, A, in the non-biased state of the spring element 400, a first distance, di, is defined between the peak 450 of the ridge and the second axis, B. In a direction parallel to the first axis, A, in the non-biased state of the spring element 400, a second distance, d₂, is defined between the respective tip portion 462a, 462b and the second axis, B. The relation between the first distance, d₁, and the second distance, d₂, fulfils |d₁|>d₂|, i.e. abs(d₁)>abs(d₂). Furthermore, both the peak 450 and the tip portions 462a, 462b are located on the same side of the second axis B, such that both d₁ and d₂ extend from the second axis B in the same radial direction along the first axis A, for example both upwards or both downwards, and not in opposite directions, for example d₁ downwards and d₂ upwards. According to an example, the respective tip portion 462a, 462b may be rounded.

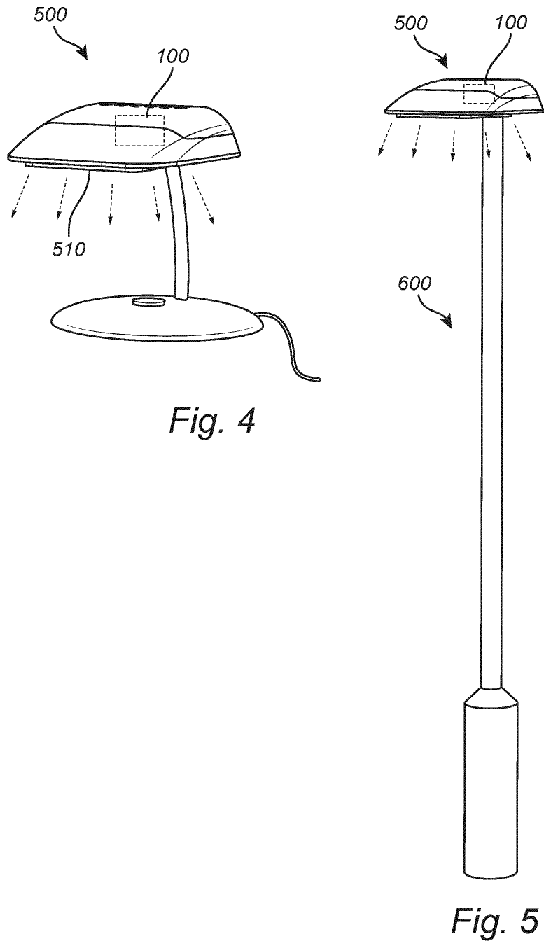

FIG. 4 schematically shows a lighting device 500. Here, the lighting device 500 is exemplified as a lamp, but is should be noted that the lighting device 500 may be substantially any lighting device, such as a lighting arrangement, luminaire, or the like. The lighting device 500 comprises at least one light source 510. The lighting device 500 further comprises an arrangement 100, as schematically indicated by the dashed lines, according to an exemplifying embodiment of the present invention.

FIG. 5 schematically shows a light pole 600. The light pole 600, arranged for street light illumination, comprises a lighting device 500, which in turn comprises an arrangement 100 according to the present invention.

The person skilled in the art realizes that the present invention by no means is limited to the preferred embodiments described above. On the contrary, many modifications and variations are possible within the scope of the appended claims. For example, one or more components of the arrangement 100 such as the housing 200, the electrical connector 300, the spring element 400, etc., may have different shapes, dimensions and/or sizes than those depicted/described.

1. Arrangement, comprising
a housing, comprising
a first housing portion, and
a second housing portion, wherein the first housing portion and the second housing portion are releasably attachable to each other,
an electrical connector, at least partially enclosed by the housing, wherein the electrical connector comprises
a male connector element attached to the first housing portion, and
a female connector element attached to the second housing portion,
wherein the male connector element and the female connector element are configured for mating engagement along a first axis, A, upon attachment of the first housing portion and the second housing portion,
wherein the arrangement further comprises
a spring element arranged between the second housing portion and
the female connector element, wherein the spring element comprises a ridge extending parallel to the first axis, A,
wherein the ridge, in a non-biased state of the spring element, defines a clearance, C, between the second housing portion and the female connector element, and
wherein the ridge, in a biased state of the spring element, is at least partially flattened between the second housing portion and the female connector element.

2. The arrangement according to claim 1, wherein the spring element comprises a plate-shaped material.

3. The arrangement according to claim 1, wherein the spring element extends along a second axis, B, perpendicular to the first axis, A, and has an oblong shape, whereby the ridge extends from peripheral and oppositely arranged first and second base portions of the spring element, to a peak of the ridge, arranged at a central portion of the spring element.

4. The arrangement according to claim 3, wherein the spring element comprises first and second end portions arranged peripherally of the first and second base portions, respectively, along the second axis, B, wherein the first and second end portions are inclined with respect to the second axis, B.

5. The arrangement according to claim 4, wherein the first and second base portions are arranged tangentially with the second axis, B, and wherein the first and second end portions respectively comprises a tip portion, wherein, in a direction parallel to the first axis A, in the non-biased state of the spring element,
a first distance, d₁, defined between the peak of the ridge and the second axis, B, and
a second distance, d₂, defined between the respective tip portion and the second axis, B, fulfil |d₁|>|d₂|.

6. The arrangement according to claim 5, wherein the respective tip portion is rounded.

7. The arrangement according to claim 4, wherein the spring element comprises first and second notches extending from the first and second end portions, respectively, at least partially into the ridge, along the second axis, B, wherein the first and second notches are arranged to receive a respective fastening element for attachment of the female connector element to the second housing portion.

8. The arrangement according to claim 1, wherein the electrical connector is a knife switch connector.

9. Lighting device, comprising
an arrangement according to claim 1, and
at least one light source at least partially enclosed by the housing.

10. Light pole for street light illumination, comprising a lighting device according to claim 9.
